(19) United States
(12) Patent Application Publication
(10) Pub. No.: US 2012/0144118 A1
(43) Pub. Date: Jun. 7, 2012

(54) METHOD AND APPARATUS FOR SELECTIVELY PERFORMING EXPLICIT AND IMPLICIT DATA LINE READS ON AN INDIVIDUAL SUB-CACHE BASIS

(75) Inventors: Benjamin Tsien, Fremont, CA (US); Greggory D. Donley, San Jose, CA (US)

(73) Assignee: ADVANCED MICRO DEVICES, INC., Sunnyvale, CA (US)

(21) Appl. No.: 12/962,083

(22) Filed: Dec. 7, 2010

(51) Int. Cl. G06F 12/08

(52) U.S. Cl. 711/122; 711/E12.017

(57) ABSTRACT

A method and apparatus are described for selectively performing explicit and implicit data line reads. A controller, located in a cache, individually monitors the data resource availability for each of a plurality of sub-caches also located in the cache. The controller receives a data line request, generates an individual implicit tag request for each of the sub-caches that currently have sufficient data resources to perform an implicit data line read, and generates an individual explicit tag request for each of the sub-caches that do not currently have sufficient data resources to perform an implicit data line read. Each tag request includes an address of the requested data line and an indicator, (represented by at least one bit), of whether the tag request is an explicit or implicit tag request.

### FIELD OF INVENTION

This application is related to a cache in a semiconductor device (e.g., an integrated circuit (IC)).

### BACKGROUND

Processor caches have become larger due to shrinking process geometries, as modern processors have been able to pack in larger amounts of caches on the die. A useful organization of these large caches is to split them into sub-caches. These smaller sub-caches lessen internal communications and wiring distances, which allows for a faster cycle time, increased design scalability and exposure to more parallelism due to their distributed nature.

In a typical processor, a plurality of processing cores, (e.g., central processing unit (CPU) cores, graphics processing unit (GPU) cores, and the like), retrieve data from a cache (e.g., a data cache) by sending data line requests to the cache. FIGS. 1A and 1B show a conventional processor 100 including processing cores 105₁-105_{N}, a data cache 110 and data buffers 115₁-115_{N}. The data cache 110 includes a controller 120 and sub-cache units 125₁-125_{N}. The controller 120 includes a data line tag request generation unit 130 and a resource analyzer 135.

The resource analyzer 135 monitors data resources and constantly indicates the availability of data resources in the sub-cache units 125₁-125_{N} to the data line tag request generation unit 130 via a signal 140. The data resources may include read busses, write busses, cache banks, data buffers, or other resources. In response to receiving a data line request 145 from any of the processing cores 105, the data line tag request generation unit 130 is used by the controller 120 to generate a tag request 150 that is sent to all of the sub-cache units 125. The tag request 150 may consist of an address of a requested data line and an indicator (e.g., represented by one or more bits) of whether the tag request 150 is an implicit tag request or an explicit tag request. An implicit tag request enables a requested data line to be accessed immediately without delay by performing an implicit data line read, if the requested data line is stored in the sub-cache unit 125. An explicit tag request requires the controller 120 to perform an additional step of sending a data request to a sub-cache unit 125 in order to access a requested data line by performing an explicit data line read.

As shown in FIG. 1A, if the resource analyzer 135 indicates to the data line tag request generation unit 130 via signal 140 that there are not sufficient data resources (i.e., the data resources are occupied) in one or more of the data sub-cache units 125, the controller 120 issues a explicit tag request 150 to each of the sub-cache units 125, which respond by sending a tag response 155 to the controller 120. If any of the tag responses 155 indicate that the requested data lines are stored in one or more of the sub-cache units 125, (i.e., a “tag hit”), the controller 120 must send data requests 160 to those sub-cache units 125 to retrieve the requested data lines (i.e., schedule a data line read), which respond by sending the accessed data lines 170 to the data buffers 115. The data lines 170 may then be provided to the processing cores 105. For example, the controller 120 may deliver a data response (not shown) to the particular processing core 105 that sent a data line request 145. Such a data response may include the data line 170 requested by the particular processing core 105.

As shown in FIG. 1B, if the resource analyzer 135 indicates to the data line tag request generation unit 130 via signal 140 that there are sufficient data resources in all of the sub-cache units 125, the controller 120 issues a tag request 152 with an implicit indicator to each of the sub-cache units 125, which respond by sending a tag response 155 to the controller 120 and performing an implicit data line read, without the need for the controller to send a data request. The sub-cache units 125 send the accessed data lines 170 to the data buffer 115. The data lines 170 may then be provided to the processing cores 105.

When tags in a sub-cache unit 125 are accessed to determine whether a data line is contained in data-cache 110, waiting for a tag hit to be determined before starting the data access results in higher latency. However, starting the data access immediately without waiting for the tag hit determination requires data resources to be reserved in advance, which are then wasted if the tag access results in a miss (i.e., the requested data line is not stored in the data cache 110). The controller 120 switches between explicit and implicit tag request modes based on the instantaneous availability of data resources, when the tag request 152 is issued to the sub-cache units 125.

The controller 120 may interact with the sub-cache units 125 to manipulate data resources, which as previously mentioned may include read busses, write busses, cache banks, data buffers, or other resources. An implicit read reduces the latency of a read access by speculatively reserving the resources needed for a data transfer, prior to the knowledge of a cache hit. By initiating an implicit read, overall cache access latency is reduced by allowing a sub-cache unit 125 to immediately use the pre-allocated resources to read out the data if there is a cache hit, without signaling the controller 120 again to schedule the resources to that sub-cache unit 125, incurring a round-trip latency between the controller 120 and the sub-cache 125, in addition to the scheduling latency.

If any data resources are already occupied for one of the sub-cache units 125, use of an implicit read may be restricted.

### SUMMARY OF EMBODIMENTS OF THE PRESENT INVENTION

A method and apparatus are described for selectively performing explicit and implicit data line reads. A controller, located in a cache, individually monitors the data resource availability for each of a plurality of sub-caches also located in the cache. The controller receives a data line request, generates an individual implicit tag request for each of the sub-caches that currently have sufficient data resources to perform an implicit data line read, and generates an individual explicit tag request for each of the sub-caches that do not currently have sufficient data resources to perform an implicit data line read. Each tag request includes an address of the requested data line and an indicator, (represented by at least one bit), of whether the tag request is an explicit or implicit tag request.

### BRIEF DESCRIPTION OF THE DRAWINGS

A more detailed understanding may be had from the following description, given by way of example in conjunction with the accompanying drawings wherein:

FIG. 1A shows a processor that generates an explicit data line tag request in a conventional manner;

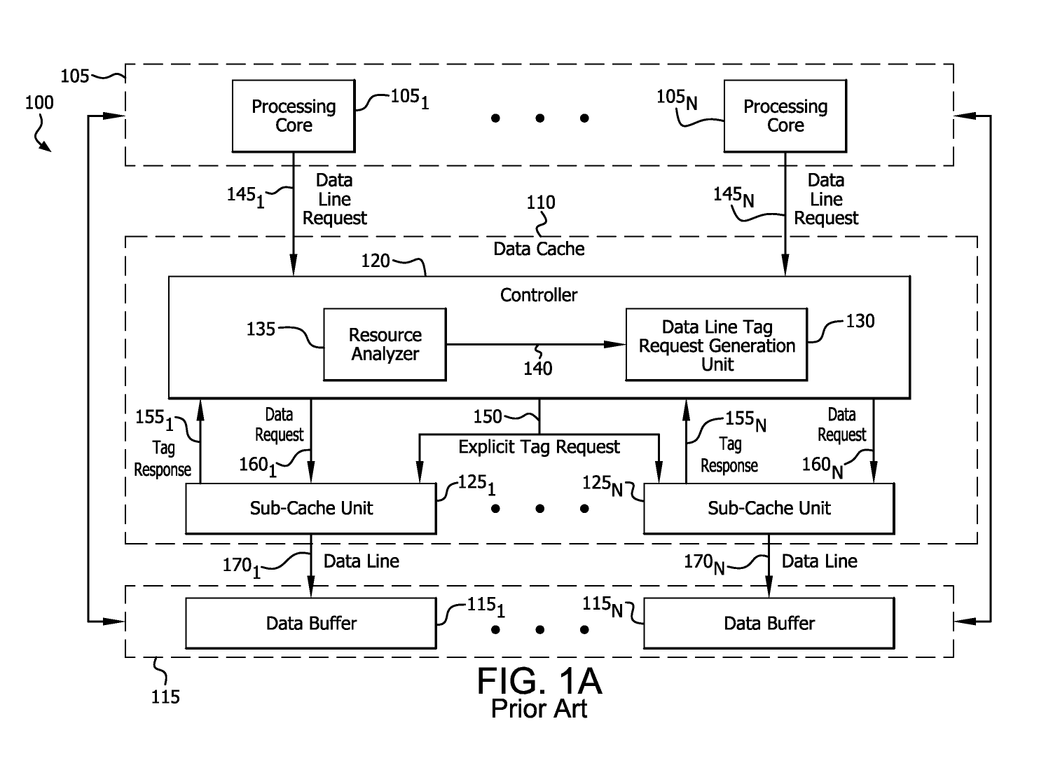

FIG. 1B shows a processor that generates an implicit data line tag request in a conventional manner;

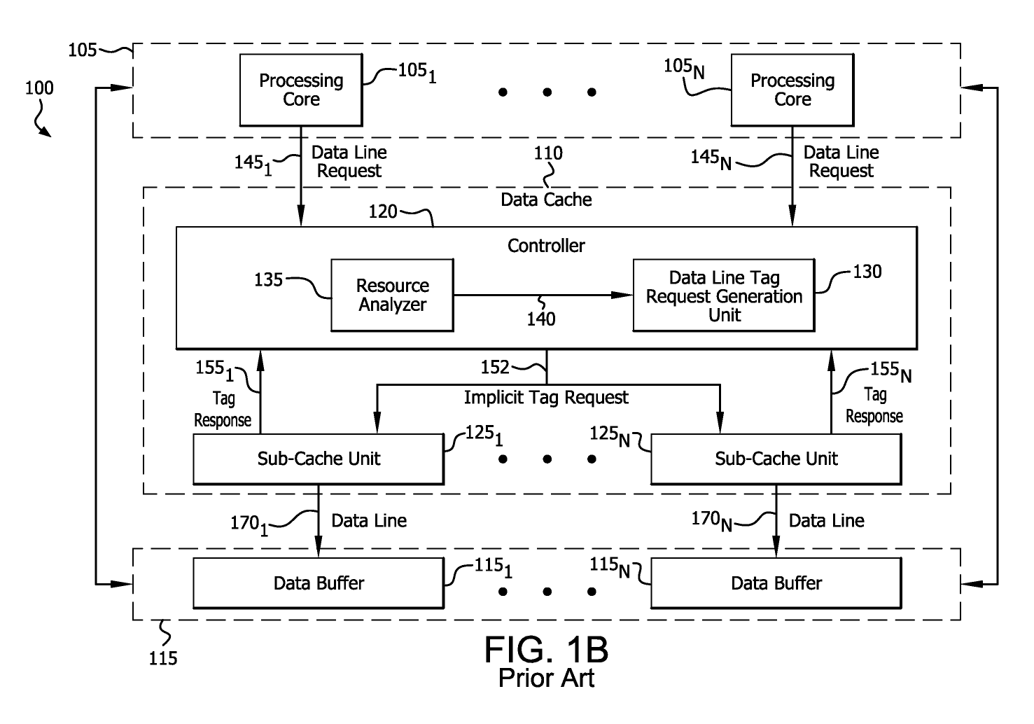

FIG. 2 shows a processor that generates explicit and implicit data line tag requests on an individual sub-cache basis in accordance with an embodiment of the present invention; and

FIG. 3 is a flow diagram of a procedure for generating data line tag requests in accordance with an embodiment of the present invention.

### DETAILED DESCRIPTION

Restrictions on implicit reads can be removed by allowing partial implicit reads of those sub-cache units with available data resources that may be scheduled for implicit reads, while those sub-cache units that do not currently have available data resources (i.e., the data resources are occupied) are scheduled as tag lookups (explicit reads). In one embodiment, when a cache hit is found on a sub-cache unit that was scheduled for an implicit read, the latency savings of the implicit read is realized. If the cache hit is found on a sub-cache unit that was not scheduled as an implicit read, (e.g., a tag lookup, explicit read), a data access will need to be separately scheduled.

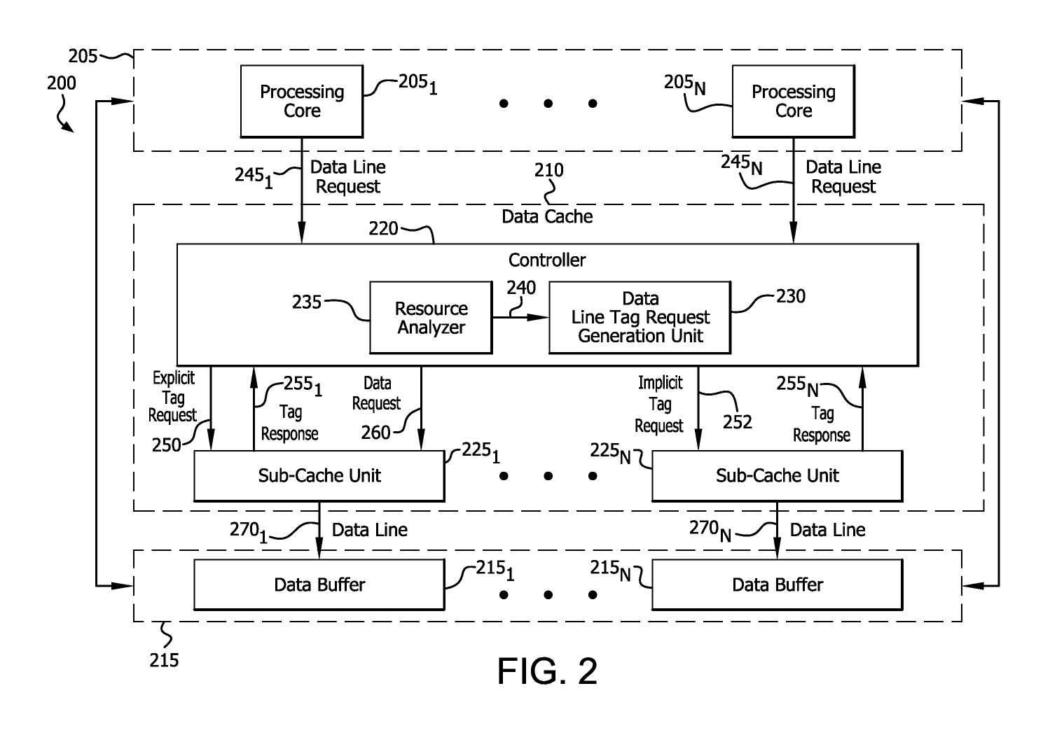

FIG. 2 shows a processor 200 that generates explicit and implicit data line tag requests directed to sub-cache units on an individual basis in accordance with an embodiment of the present invention. The processor 200 includes processing cores 205₁-205_{N}, a data cache 210 and data buffers 215₁-215_{N}. The data cache 210 includes a controller 220 and sub-cache units 225₁-225_{N}. The controller 220 includes a data line tag request generation unit 230 and a resource analyzer 235.

The resource analyzer 235 monitors data resources associated with each of the sub-cache units 225 on an individual basis, and constantly indicates to the data line tag request generation unit 230 via a signal 240 whether or not there are currently sufficient data resources available in each particular sub-cache unit 225. In response to receiving a data line request 245 from any of the processing cores 205, the data line tag request generation unit 230 is used by the controller 220 to generate an individual explicit tag request 250 or an individual implicit tag request 252 that is sent to a particular sub-cache unit 225. Each of the tag requests 250 and 252 may consist of an address of a requested data line and an indicator (e.g., represented by one or more bits) of whether the tag request is an explicit tag request or an implicit tag request. The explicit tag request 250 requires the controller 220 to perform an additional step of sending a data request 260 to the sub-cache unit 225 in order to access a requested data line by performing an explicit data line read. The implicit tag request 252 enables a requested data line to be accessed immediately without delay by performing an implicit data line read.

As shown in FIG. 2, if the resource analyzer 235 indicates to the data line tag request generation unit 230 via signal 240 that there are not sufficient data resources to perform an implicit data line read in a particular one of the data sub-cache units 225, the controller 220 issues a tag request 250 with an explicit indicator to the particular sub-cache unit 225, which responds by sending a tag response 255 to the controller 220. If the tag response 255 indicates that the requested data line is stored in the particular sub-cache unit 225, (i.e., a “tag hit”), the controller 220 must send a data request 260 to the particular sub-cache unit 225 to retrieve the requested data line (i.e., schedule a data line read), which responds by sending the accessed data line 270 to the data buffer 215. The data line 270 may then be provided to the processing core 205. For example, the controller 220 may deliver a data response (not shown) to the particular processing core 205 that sent a data line request 245. Such a data response may include the data line 270 requested by the particular processing core 205.

If the resource analyzer 235 indicates to the data line tag request generation unit 230 via signal 240 that there are sufficient data resources to perform an implicit data line read in a particular one of the data sub-cache units 225, the controller 220 issues a tag request 252 with an implicit indicator to the particular sub-cache unit 225, which responds by sending a tag response 255 to the controller 220 and performing an implicit data line read, without the need for the controller 220 to send a data request.

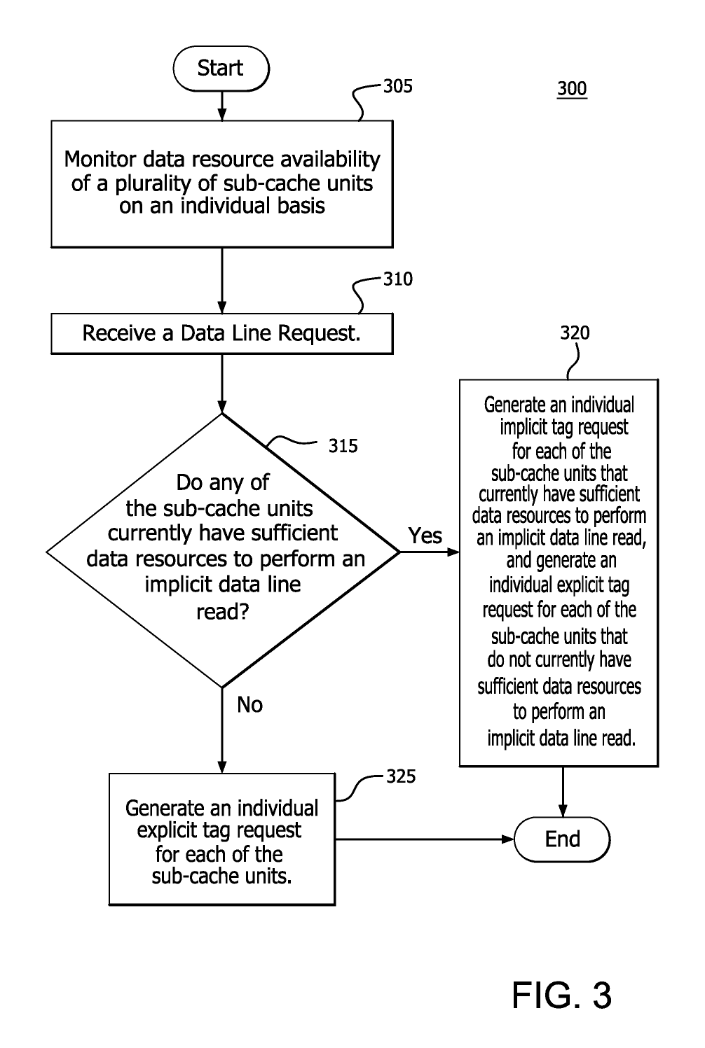

FIG. 3 is a flow diagram of a procedure 300 for generating data line tag requests in accordance with an embodiment of the present invention. In step 305, data resource availability of a plurality of sub-cache units is monitored on an individual basis. In step 310, a data line request is received (e.g., from a processing core). In step 315, a determination is made as to whether any of the sub-cache units currently have sufficient data resources to perform an implicit data line read. If the determination made in step 315 is positive, an individual implicit tag request is generated for each of the sub-cache units that currently have sufficient data resources to perform an implicit data line read, and an individual explicit tag request is generated for each of the sub-cache units that do not currently have sufficient data resources to perform an implicit data line read (step 320). If the determination made in step 315 is negative, an individual explicit tag request is generated for each of the sub-cache units (step 325).

Although features and elements are described above in particular combinations, each feature or element can be used alone without the other features and elements or in various combinations with or without other features and elements. The apparatus described herein may be manufactured using a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data, (e.g., netlists, GDS data, or the like), that may be used to perform a manufacturing process implemented in a semiconductor fabrication facility. The manufacturing process may be adapted to manufacture semiconductor devices (e.g., processors) that embody various aspects of the present invention.

Suitable processors include, by way of example, a general purpose processor, a special purpose processor, a conventional processor, a digital signal processor (DSP), a plurality of microprocessors, a graphics processing unit (GPU), a DSP core, a controller, a microcontroller, application specific integrated circuits (ASICs), field programmable gate arrays (FPGAs), any other type of integrated circuit (IC), and/or a state machine, or combinations thereof.

What is claimed is:

1. A method, performed in association with a cache having a plurality of sub-caches, of selectively performing explicit and implicit data line reads, the method comprising:
monitoring data resource availability of each of the sub-caches;
receiving a data line request;
determining whether any of the sub-caches currently have sufficient data resources to perform an implicit data line read; and
generating an individual implicit tag request for each of the sub-caches that currently have sufficient data resources to perform an implicit data line read.

2. The method of claim 1 further comprising:
generating an individual explicit tag request for each of the sub-caches that do not currently have sufficient data resources to perform an implicit data line read.

3. The method of claim 1 wherein the tag request includes an address of the requested data line.

4. The method of claim 1 wherein the tag request includes an indicator of whether the tag request is an explicit or implicit tag request.

5. The method of claim 4 wherein the indicator is represented by at least one bit.

6. The method of claim 1 further comprising:
a controller sending an explicit tag request to a particular sub-cache that does not currently have sufficient data resources to perform an implicit data line read;
the particular sub-cache sending a tag response to the controller; and
the controller sending a data request to the particular sub-cache in order to access a requested data line by performing an explicit data line read.

7. The method of claim 1 further comprising:
a controller sending an implicit tag request to a particular sub-cache that currently has sufficient data resources to perform an implicit data line read; and
the particular sub-cache sending a tag response to the controller.

8. A semiconductor device comprising:
a plurality of processing cores, each processing core being configured to generate a data line request; and
a cache including a controller and a plurality of sub-caches, wherein the controller is configured to monitor data resource availability of each of the sub-caches, receive a data line request from one of the processing cores, determine whether any of the sub-caches currently have sufficient data resources to perform an implicit data line read, and generate an individual implicit tag request for each of the sub-caches that currently have sufficient data resources to perform an implicit data line read.

9. The semiconductor device of claim 8 wherein the controller is further configured to generate an individual explicit tag request for each of the sub-caches that do not currently have sufficient data resources to perform an implicit data line read.

10. The semiconductor device of claim 8 wherein the tag request includes an address of the requested data line.

11. The semiconductor device of claim 8 wherein the tag request includes an indicator of whether the tag request is an explicit or implicit tag request.

12. The semiconductor device of claim 11 wherein the indicator is represented by at least one bit.

13. The semiconductor device of claim 8 wherein the controller sends an explicit tag request to a particular sub-cache that does not currently have sufficient data resources to perform an implicit data line read, the particular sub-cache sends a tag response to the controller, and the controller sends a data request to the particular sub-cache in order to access a requested data line by performing an explicit data line read.

14. The semiconductor device of claim 8 wherein the controller sends an implicit tag request to a particular sub-cache that currently has sufficient resources to perform an implicit data line read, and the particular sub-cache sends a tag response to the controller.

15. A cache comprising:
a plurality of sub-caches; and
a controller configured to monitor data resource availability of each of the sub-caches, receive a data line request, determine whether any of the sub-caches currently have sufficient data resources to perform an implicit data line read, and generate an individual implicit tag request for each of the sub-caches that currently have sufficient data resources to perform an implicit data line read.

16. The cache of claim 15 wherein the controller is further configured to generate an individual explicit tag request for each of the sub-caches that do not currently have sufficient data resources to perform an implicit data line read.

17. The cache of claim 15 wherein the tag request includes an address of the requested data line.

18. The cache of claim 15 wherein the tag request includes an indicator of whether the tag request is an explicit or implicit tag request, wherein the indicator is represented by at least one bit.

19. The cache of claim 15 wherein the controller sends an explicit tag request to a particular sub-cache that does not currently have sufficient data resources to perform an implicit data line read, the particular sub-cache sends a tag response to the controller, and the controller sends a data request to the particular sub-cache in order to access a requested data line by performing an explicit data line read.

20. The semiconductor device of claim 15 wherein the controller sends an implicit tag request to a particular sub-cache that currently has sufficient resources to perform an implicit data line read, and the particular sub-cache sends a tag response to the controller.

21. A computer-readable storage medium configured to store a set of instructions used for manufacturing a semiconductor device, wherein the semiconductor device comprises:
a plurality of sub-caches; and
a controller configured to monitor data resource availability of each of the sub-caches, receive a data line request, determine whether any of the sub-caches currently have sufficient data resources to perform an implicit data line read, and generate an individual implicit tag request for each of the sub-caches that currently have sufficient data resources to perform an implicit data line read.

22. The computer-readable storage medium of claim 21 wherein the instructions are Verilog data instructions.

23. The computer-readable storage medium of claim 21 wherein the instructions are hardware description language (HDL) instructions.
